(19) United States
(12) Patent Application Publication
(10) Pub. No.: US 2025/0218276 A1
(43) Pub. Date: Jul. 3, 2025

(54) A CRIME PREVENTION, MONITORING AND ALERTING DEVICE AND METHOD THEREOF

(71) Applicant: Ankita Dasgupta, Bengaluru (IN)

(72) Inventor: Ankita Dasgupta, Bengaluru (IN)

(21) Appl. No.: 18/707,303

(22) PCT Filed: Jan. 3, 2022
(86) PCT No.: PCT/IB2022/050010

§ 371 Date: May 3, 2024

(30) Foreign Application Priority Data
Dec. 1, 2021 (IN) 202141055695

(51) Int. Cl. G08B 25/01; G08B 15/02

(52) U.S. Cl. CPC G08B 25/016; G08B 15/02

(57) ABSTRACT

In accordance with an aspect of the present invention, a crime prevention, monitoring and alerting device is provided. The crime prevention, monitoring and alerting device includes a personal protection device having a refillable ampule unit with a button, a plurality of sensors, an audio-visual capturing module, a storage device a sound unit and a microcontroller. The crime prevention, monitoring and alerting device then includes a central server with a machine learning unit and an artificial intelligence unit. The crime prevention, monitoring and alerting device further includes a communication unit. In an embodiment, the communication unit to communicate data to security group and emergency contacts, identify presence of anyone at the geo location and notify about the crime, receive request to identify safest route and provide safest route based on time, location, crime, presence of security group to the user.

### FIELD OF THE INVENTION

This invention relates, generally, to the field of self-defense, more specifically the invention relates to a crime preventing, monitoring and alerting mechanism.

### BACKGROUND OF THE INVENTION

With the growing population, there has been growing rate of crime across the globe. For some countries crime, for example snatching or rape, has become a huge problem. There are thousands of cases that are reported annually in some countries but the conviction rate remains low.

A known solution for defending this kind of crime is using pepper spray, however, there has been instances where attackers snatch the pepper spray and use it for their purpose. In case the attacker manages to take possession of pepper spray and performs the crime, it is very difficult to identify the criminal later.

Generally, in few cases, people or local security agency are near the crime place but they are not aware of the crime being performed and hence, could not help to avoid such crimes.

One other know solution is mobile application that can be used to provide SOS calls but in most of the cases users are not in the position to open the application at the time of incident.

Specifically, if a user is in a new city, the user is unaware of the path he/she is taking for his/her destination and wishes to identify a safest route, however, present technology does not solve this problem of the user.

Hence, there is a critical need to provide a solution that can solve above mentioned problems.

### SUMMARY OF THE INVENTION

The following description is a complete disclosure and therefore lays down the aspects of the solution being proposed. A person skilled in the art would appreciate that this complete specification may comprise one or more elements and sub-elements thereof, including but not limited to, routines, methods, processes, operations, systems, apparatuses and devices, whether named or unnamed, without deviating from the scope of this complete application. Those skilled in the art would also appreciate that the invention disclosed in this complete application may be carried out by methods and/or through systems which are equivalent to the solution disclosed in this complete application, and therefore any definition/description of the said equivalents in the complete specification should be construed as being amply covered in the complete specification.

The present invention is intended to address at least one of the above-mentioned problems and/or disadvantages and to provide a suitable solution. Accordingly, an aspect of the present invention is to provide a crime prevention, monitoring and alerting device and method thereof.

In accordance with an aspect of the present invention, a crime prevention, monitoring and alerting device is provided. The crime prevention, monitoring and alerting device includes a personal protection device. In an embodiment, the personal protection device includes a refillable ampule unit with a button configured to carry a human irritant chemical so that the refillable ampule unit sprays the human irritant chemical on an attacker with a push of the push button. In an embodiment, the personal protection device then includes a plurality of sensors configured to detect behavioral changes, movement rate, distance of the attacker and geo location of the personal device so as to calculate required flow rate of spray of the human irritant chemical. In yet another embodiment, the personal protection device also includes an audio-visual capturing module configured to capture images, audios and videos. In an embodiment, the personal protection device further includes a storage device configured to store output of the audio-visual capturing module, a sound unit configured to generate loud sound and a microcontroller. In an embodiment, the microcontroller is configured to regulate flow of spray of the human irritant chemical at the rate calculated by the plurality of sensors, send files stored in the storage device along with the geo-location of the personal device to central serval via a communication channel in real-time and generate sound through the sound unit. The crime prevention, monitoring and alerting device then includes a central server. In an embodiment, the server includes a machine learning unit. In yet another embodiment, the machine learning unit is configured to verify validity of crime, categorize type of crime, tag the crime with geo location, attach files received from the storage device to the tagged crime. In one another embodiment, the server then includes an artificial intelligence unit. In an embodiment, the artificial intelligence unit is configured to identify intensity of crime by evaluating category, attached files and output of the plurality of sensors, identify if anyone else is at the geo location, provide a safest route for a user based on time and presence of security group and send and receive information to and from communication channel. The crime prevention, monitoring and alerting device further includes a communication unit. In an embodiment, the communication unit is configured to inform security group and emergency contacts about the crime, image of criminal, geo location and time, identify presence of anyone at the geo location and notify about the crime, receive request to identify safest route by the user, send the request to the artificial intelligence unit to provide safest route based on time, location, crime, presence of security group, receive the safest route from the artificial intelligence unit and provide the safest route to the user.

In accordance with an aspect of the present invention, a method to prevent, monitor and alert crime is provided. The method to prevent, monitor and alert crime includes steps of configuring a personal protection device. In an embodiment, configuring the personal protection device includes steps of configuring a refillable ampule unit with a button so as to carry a human irritant chemical and spray the human irritant chemical on an attacker with a push of the push button. In one embodiment, configuring the personal protection device further includes steps of configuring a plurality of sensors so as to detect behavioral changes, movement rate, distance of the attacker and geo location of the personal device to calculate required flow rate of spray of the human irritant chemical. Configuring the personal protection device then includes steps of configuring an audio-visual capturing module so as to capture images, audios and videos, configuring a storage device so as to store output of the audio-visual capturing module, configuring a sound unit so as to generate loud sound and configuring a microcontroller. In another embodiment, the microcontroller is configured so as to regulating flow of spray of the human irritant chemical at the rate calculated by the plurality of sensors sending files stored in the storage device along with the geo-location of the personal device to central serval via a communication channel in real-time and generating sound through the sound unit. The method to prevent, monitor and alert crime then includes steps of setting a central server. In an embodiment, setting of the central server includes steps of configuring a machine learning unit so as to, verifying validity of crime, categorizing type of crime, tagging the crime with geo location and attaching files received from the storage device to the tagged crime. Setting a central server further includes steps of configuring an artificial intelligence unit. In an embodiment, the artificial intelligence unit is configured so as to follow steps of identifying intensity of crime by evaluating category, attached files and output of the plurality of sensors, identifying if anyone else is at the geo location, provide a safest route for a user based on time and presence of security group and sending and receiving information to and from communication channel. The method to prevent, monitor and alert crime further includes steps of configuring a communication unit. In an embodiment, the communication unit is configured so as to follow steps of informing security group and emergency contacts about the crime, image of criminal, geo location and time, identifying presence of anyone at the geo location and notify about the crime, receiving request to identify safest route by the user, sending the request to the artificial intelligence unit to provide safest route based on time, location, crime, presence of security group, receiving the safest route from the artificial intelligence unit and providing the safest route to the user.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF DRAWINGS

The above and other aspects, features and advantages of certain exemplary embodiments of the present invention will be more apparent from the following detailed description taken in conjunction with the accompanying drawings, in which:

FIG. 1 illustrates a high-level block diagram of a preferred embodiment of the

claimed device to prevent, monitor and alert crime,

FIG. 2 illustrates a block diagram of an exemplarily embodiment of a personal protection device of the claimed system,

FIG. 3 provides a flow chart of a non-limiting, exemplary embodiment of the claimed method.

Persons skilled in the art will appreciate that elements in the figures are illustrated for simplicity and clarity and may have not been drawn to scale. For example, the dimensions of some of the elements in the figure may be exaggerated relative to other elements to help to improve understanding of various exemplary embodiments of the present disclosure.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

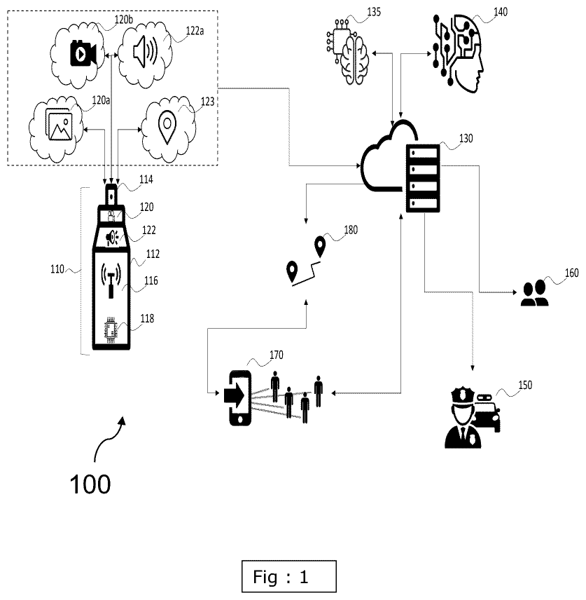

FIG. 1 to FIG. 3, discussed below, are non-limiting illustrations which may be used to explain and describe the invention used to explain and describe the invention disclosed herein. Persons skilled in the art will appreciate that the purpose of these figures is to provide clarity on the concepts associated with the various technical embodiments of this invention. These figures may include block diagrams and/or flowcharts and/or other simplistic representations and may not always indicate the real time operations taking place in the invention.

Accordingly, FIG. 1 illustrates a high-level block diagram of a preferred embodiment of the claimed device to prevent, monitor and alert crime 100. In accordance with an aspect of the present invention, the crime prevention, monitoring and alerting device includes a personal protection device 110.

In an embodiment, the personal protection device 110 includes a refillable ampule unit 112. The refillable ampule unit 112 can be refilled by a human irritant chemical. In an aspect, the refillable ampule unit 112 includes a button 114 that can be pushed to spray the filled human irritant chemical.

In an exemplary embodiment, the refillable ampule unit 112 can be made up of a polypropylene by using an injection blow molding process so that the refillable ampule unit 112 can be designed of various size and shape and the polypropylene material does not hinder communication network. The refillable ampule unit 112 can also be configured with an indicator to notify if the human irritant reaches to a level where it required to be refilled.

In one another exemplary embodiment, the human irritant can be made from di-hydro-capsaicin and capsaicin with a composition of trans-8-methyl-N-vanillyl-6-nonenamide with 80 to 90%.

In another embodiment, the human irritant chemical includes a fluorescent dye so that it can mark the attackers who can be identified easily.

In an embodiment, the personal protection device 110 then includes a plurality of sensors 116 configured to detect behavioral changes, movement rate, distance of the attacker and geo location of the personal protection device so as to calculate required flow rate of spray of the human irritant chemical.

In an exemplary embodiment, the plurality of sensors 116 may include an accelerometer so that it detects user movement and anomaly in case there is a sudden change of state, for a non-limiting example, it can detect change is speed if a person is walking and suddenly if the person starts moving in a vehicle.

In one another exemplary embodiment, the plurality of sensors 116 may include an IR sensor to detect distance of attacker from device and can share data to enable a microcontroller 118 to calculate rate of flow of spray and distance that it requires to cover.

In yet another exemplary embodiment, the plurality of sensors 116 can include behavioral sensor to detect feeling, change of behavior, and other health data for analysis.

In an embodiment the plurality of sensors 116 includes sensors of a wearable device that can be configured to provide health data and/or behavioral data to the microcontroller.

In yet another embodiment, the personal protection device 110 also includes an audio-visual capturing module 120 configured to capture images 120a, audios and videos 120b. The personal protection device 110 further includes a storage device configured to store output of the audio-visual capturing module 120, a sound unit 122 configured to generate loud sound 122a and the microcontroller 118.

In one embodiment, the sound unit 122 is configured with a predefined time so that the sound unit 122 generates loud sound 122a in case threat is not neutralized within the predefined time. In an embodiment, the predefined time can be configured or modified.

In an embodiment, the microcontroller 118 is configured to regulate flow of spray of the human irritant chemical at the rate calculated by the plurality of sensors 116, send files 120a, 120b, 122a stored in the storage device along with the geo-location 123 of the personal protection device 110 to a central serval 130 via a communication channel in real-time.

In an embodiment, the communication channel can be any communication channel to send or receive data.

The crime prevention, monitoring and alerting device then includes the central server 130. In an embodiment, the central server 130 includes a machine learning unit 135. In yet another embodiment, the machine learning unit 135 is configured to verify validity of crime, categorize type of crime, tag the crime with geo location, attach files received from the storage device to the tagged crime.

In a preferred embodiment, the machine learning unit 135 compares data received by microcontroller 118 and auto-learns to verify if crime was real or fake, what was the intensity of crime on a scale of predetermined parameters, what was type of the crime based on certain defined crimes and in case a new crime is performed then it can seek help to identify type of crime and learn it for any other occurrence of similar crime. The machine learning unit 135 also captures geo location 123 of crime and attach the geo location 123 with category of crime. The machine learning unit also extracts image 120a of criminal and attach the image 120a with crime that can be processed by security group 150 for a non-limiting example, either to identify criminal or to blacklist the criminal or both.

In one another embodiment, the central server 130 also includes an artificial intelligence unit 140 that is configured to identify intensity of crime by evaluating category, attached files and output of the plurality of sensors 116, identify if anyone else is at the geo location 123, provide a safest route for a user based on time and presence of security group 150 and send and receive information to and from communication channel. In a preferred embodiment, the artificial intelligence unit 140 gathers data from the plurality of sensors 116 and analyses action to perform.

The crime prevention, monitoring and alerting device further includes a communication unit. In an embodiment, the communication unit is configured to inform security group 150 and emergency contacts 160 about the crime, image 120a of criminal, geo location 123 and time, identify presence of anyone at the geo location and notify about the crime, receive request to identify safest route 180 by the user 170, send the request to the artificial intelligence unit 140 to provide safest route 180 based on time, location, crime, presence of security group, receive the safest route 180 from the artificial intelligence unit 140 and provide the safest route to the user 170.

In yet another embodiment, the personal protection device 110 includes a power source so as to provide power to the plurality of sensors 116, the audio-visual capturing device 120, the storage device, the sound unit 122 and the microcontroller 118. In an embodiment the power source can be a rechargeable power source.

In one embodiment, the personal protection device 110 includes a chain with a sensor to carry the personal protection device 110 configured to notify microcontroller 118 in case of any damage in the chain. In a non-limiting example, if the attacker snatches the personal protection device 110, the chain would break and the sensor would notify the microcontroller 118 that the chain is damaged and deactivates spray so that the attacker cannot use the personal protection device 110 on user.

In an embodiment, a mobile application can be configured with the crime prevention, monitoring and altering device to communicate with the central server 130 and to provide data of plurality of sensors 116 in a mobile device or the wearable device that can be configured to provide health data and/or behavioral data to the microcontroller 118 or the central server 130.

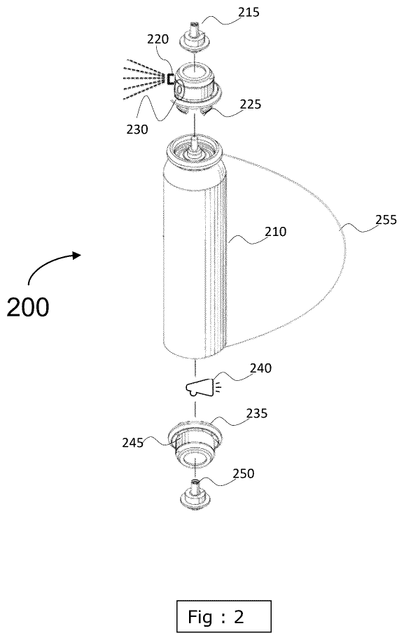

FIG. 2 illustrates a block diagram of an exemplarily embodiment of a personal protection device 200, In accordance with an aspect of the present invention, the personal protection device 200 has a refillable ampule unit 210. The refillable ampule unit 210 can be refilled by a human irritant chemical. In an aspect, the refillable ampule unit 210 includes a button 215 that can be pushed to spray 220 the filled human irritant chemical.

In an embodiment, the refillable ampule unit 210 can also be configured with an indicator to notify if the human irritant reaches to a level where it required to be refilled.

In one another exemplary embodiment, the human irritant can be made from di-hydro-capsaicin and capsaicin with a composition of trans-8-methyl-N-vanillyl-6-nonenamide with 80 to 90%.

In another embodiment, the human irritant chemical includes a fluorescent dye so that it can mark the attackers who can be identified easily.

In an embodiment, the personal protection device 200 then includes a plurality of sensors 225 configured to detect behavioral changes, movement rate, distance of the attacker and geo location of the personal protection device so as to calculate required flow rate of spray of the human irritant chemical.

In an exemplary embodiment, the plurality of sensors 225 may include an accelerometer so that it detects user movement and anomaly in case there is a sudden change of state, for a non-limiting example, it can detect change is speed if a person is walking and suddenly if the person starts moving in a vehicle.

In one another exemplary embodiment, the plurality of sensors 225 may include an IR sensor to detect distance of attacker from device and can share data to enable a microcontroller 245 to calculate rate of flow of spray 215 and distance that it requires to cover.

In yet another exemplary embodiment, the plurality of sensors 225 can include behavioral sensor to detect feeling, change of behavior, and other health data for analysis.

In an embodiment the plurality of sensors 225 includes sensors of a wearable device that can be configured to provide health data and/or behavioral data to the microcontroller.

In yet another embodiment, the personal protection device 200 also includes an audio-visual capturing module 230 configured to capture images, audios and videos. The personal protection device 200 further includes a storage device 235 configured to store output of the audio-visual capturing module 230, a sound unit 240 configured to generate loud sound and the microcontroller 245.

In one embodiment, the sound unit 240 is configured with a predefined time so that the sound unit 240 generates loud sound in case threat is not neutralized within the predefined time. In an embodiment, the predefined time can be configured or modified.

In an embodiment, the microcontroller 245 is configured to regulate flow of spray 220 of the human irritant chemical at the rate calculated by the plurality of sensors 225, send files, stored in the storage device 235 along with the geo-location of the personal protection device 200 to a central serval via a communication channel in real-time.

In one other embodiment, the microcontroller 245 stores data locally in case there is no communication network and pushes data to the central server once communication network is available.

In yet another embodiment, the personal protection device 220 includes a power source 250 so as to provide power to the plurality of sensors 225, the audio-visual capturing device 230, the storage device 235, the sound unit 240 and the microcontroller 245. In an embodiment the power source can be a rechargeable power source 250.

In one embodiment, the personal protection device 200 includes a chain 255 with a sensor to carry the personal protection device 200 configured to notify microcontroller 245 in case of any damage in the chain 255. In a nonlimiting example, if the attacker snatches the personal protection device 200, the chain would break and the sensor would notify the microcontroller 245 that the chain 255 is damaged and deactivates spray so that the attacker cannot use the personal protection device 200 on user.

In an embodiment, the personal protection device can be paired with a mobile application to communicate with the central server and to provide data of sensors in a mobile device or the wearable device that can be configured, for a non-limiting example, to provide health data and/or behavioral data to the microcontroller 245 or the central server.

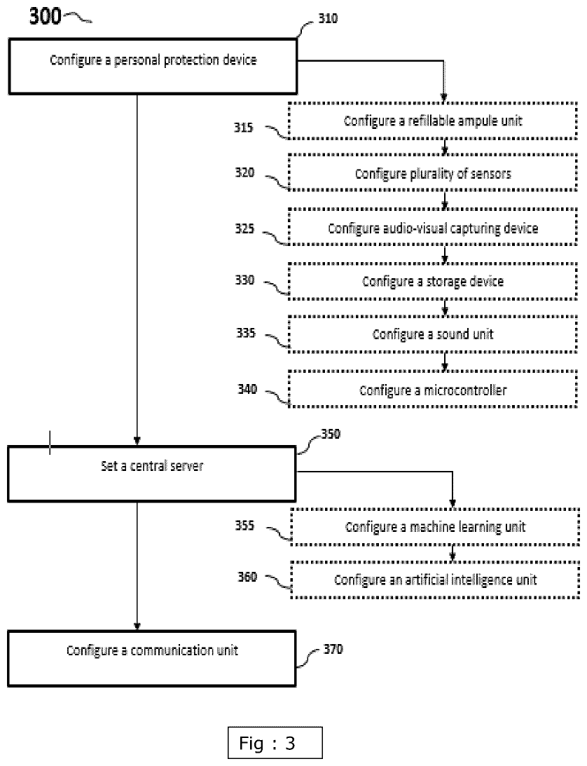

FIG. 3 illustrates a flow chart of a non-limiting, exemplary embodiment of the claimed method to prevent, monitor or alert crime 300, At Step 310, in accordance with an aspect of the present invention, a personal protection device is configured. In an embodiment the personal protection device is configured by configuring a refillable ampule unit at step 315, having a button so that the ampule unit includes a human irritant chemical that can be sprayed on an attacker with a push of the button.

In an exemplary embodiment, the ampule can be made up of a polypropylene by using an injection blow molding process so that the ampule unit can be designed of various size and shape and the polypropylene material does not hinder communication network. The ampule unit can also be configured with an indicator to notify if the human irritant reaches to a level where it required to be refilled.

In one another exemplary embodiment, the human irritant can be made from di-hydro-capsaicin and capsaicin with a composition of trans-8-methyl-N-vanillyl-6-nonenamide with 80 to 90%.

In an embodiment, the ampule unit is designed in a manner that it can be refilled so as to make the device cost efficient.

A plurality of sensors is configured at step 320, so that various parameters like behavioral changes, movement rate, distance of the attacker and geo location of the personal protection device can be detected to enable calculation of required flow rate of spray of the human irritant chemical.

In an exemplary embodiment, the plurality of sensors may include an accelerometer so that it detects user movement and anomaly in case there is a sudden change of state, for a non-limiting example, it can detect change is speed if a person is walking and suddenly if the person starts moving in a vehicle.

In one another exemplary embodiment, the plurality of sensors may include an IR sensor to detect distance of attacker from device and can share data to enable a microcontroller to calculate rate of flow of spray and distance that it requires to cover.

In yet another exemplary embodiment, the plurality of sensors can include behavioral sensor to detect feeling, change of behavior, and other health data for analysis.

In an embodiment the plurality of sensors can includes sensors of a wearable device that can be configured to provide health data and/or behavioral data to the microcontroller.

At step 325, an audio-visual capturing module is configured so that it can capture images, audios and videos and then a storage device is configured at step 330, so that output of the audio-visual capturing module can be stored in the storage device.

At step 335, a sound unit is configured to generate loud sound.

In one embodiment, the sound device is configured with a predefined time so that the sound unit generates loud sound in case threat is not neutralized within the predefined time. In an embodiment, the predefined time can be configured or modified.

At step 340, the microcontroller is configured, in an aspect of the present invention. In an embodiment, the microcontroller is configured to regulate flow of spray of the human irritant chemical at the rate calculated by the plurality of sensors, send files stored in the storage device along with the geo-location of the personal protection device to central serval via a communication channel in real-time and generate sound through the sound unit.

In an embodiment, the communication channel can be any communication channel to send or receive data.

At Step 350, a central sever is configured, in an aspect of the present invention. The central server is configured with a machine learning unit at step 355. The machine learning unit is configured to verify validity of crime, categorize type of crime, tag the crime with geo location, attach files received from the storage device to the tagged crime.

In a preferred embodiment, the machine learning unit is configured to compare data received by microcontroller and auto-learns to verify if crime was real or fake, what was the intensity of crime on a scale of predetermined parameters, what was type of the crime based on certain defined crimes and in case a new crime is performed then it can seek help to identify type of crime and learn it for any other occurrence of similar crime. The machine learning unit also captures geo location of crime and attach the geo location with category of crime. The machine learning unit also extracts image of criminal and attach the image with crime that can be processed by security group for a non-limiting example, either to identify criminal or to blacklist the criminal or both.

At step 360, an artificial intelligence unit is configured with the central server. In an embodiment, the artificial intelligence unit is configured to identify intensity of crime by evaluating category, attached files and output of the plurality of sensors, identify if anyone else is at the geo location, provide a safest route for a user based on time and presence of security group and send and receive information to and from communication channel. In a preferred embodiment, the artificial intelligence unit is also configured to gather data from the plurality of sensors, analyses action to perform.

At step 370, a communication unit is configured. In an embodiment, the communication unit is configured to inform security group and emergency contacts about the crime, image of criminal, geo location and time, identify presence of anyone at the geo location and notify about the crime, receive request to identify safest route by the user, send the request to the artificial intelligence unit to provide safest route based on time, location, crime, presence of security group, receive the safest route from the artificial intelligence unit and provide the safest route to the user.

In an embodiment, the personal protection device includes a power source so as to provide power to the plurality of sensors, the audio-visual capturing device, the storage device, the sound unit and the microcontroller. In an embodiment the power source can be a rechargeable power source.

In yet another embodiment, a mobile application can be configured with the crime prevention, monitoring and altering device to communicate with the central server and to provide data of plurality of sensors in a mobile device or the wearable device that can be configured to provide health data and/or behavioral data to the microcontroller and deactivate spray so that the attacker cannot use the personal protection device 110 on user.

While the invention has been shown and described with reference to certain exemplary embodiments thereof, it will be understood by those skilled in the art that various changes in form and details may be made therein without departing from the spirit and scope of the invention as defined by the appended claims and their equivalents.

In relation to the preceding specification, it is reiterated that the present disclosure and its advantages have been described with reference to exemplary embodiments and that, a person of ordinary skill in the art would appreciate that various modifications and changes may be made, without departing from the scope of the present disclosure, as set forth in the appended claims and their equivalents. Furthermore, it is re-emphasized that the preceding specification and figures are to be regarded as illustrative examples of the present disclosure, rather than in restrictive sense. All such possible modifications are intended to be included within the scope of the present invention.

I/we claim:

1. A crime prevention, monitoring and alerting device, wherein the crime prevention, monitoring and alerting device is characterized by:
a personal protection device, wherein the personal protection device comprises:
a refillable ampule unit with a button configured to carry a human irritant chemical so that the refillable ampule unit sprays the human irritant chemical on an attacker with a push of the push button;
a plurality of sensors configured to detect behavioral changes, movement rate, distance of the attacker and geo location of the personal device so as to calculate required flow rate of spray of the human irritant chemical;
an audio-visual capturing module configured to capture images, audios and videos;
a storage device configured to store output of the audio-visual capturing module;
a sound unit configured to generate loud sound;
a microcontroller configured to:
regulate flow of spray of the human irritant chemical at the rate calculated by the plurality of sensors;
send files stored in the storage device along with the geo-location of the personal protection device to central serval via a communication channel in real-time; and
generate sound through the sound unit;
a central server, wherein the central server comprises:
a machine learning unit configured to:
verify validity of crime;
categorize type of crime;
tag the crime with geo location;
attach files received from the storage device to the tagged crime;
an artificial intelligence unit configured to:
identify intensity of crime by evaluating category, attached files and output of the plurality of sensors;
identify if anyone else is at the geo location;
provide a safest route for a user based on time and presence of security group; and
send and receive information to and from communication channel; and
a communication unit configured to:
inform security group and emergency contacts about the crime, image of criminal, geo location and time; and
identify presence of anyone at the geo location and notify about the crime;
receive request to identify safest route by the user;
send the request to the artificial intelligence unit to provide safest route based on time, location, crime, presence of security group;
receive the safest route from the artificial intelligence unit; and
provide the safest route to the user.

2. The personal protection device as claimed in claim 1, wherein, the personal protection device comprises a power source so as to provide power to the plurality of sensors, the audio-visual capturing device, the storage device, the sound unit and the microcontroller.

3. The personal protection device as claimed in claim 1, wherein, the personal protection device comprises a chain with a sensor to carry the personal protection device configured to notify microcontroller in case of any damage in the chain and deactivate spray.

4. The crime prevention, monitoring and alerting device as claimed in claim 1, wherein, the crime prevention, monitoring and alerting device can be configured through a mobile application.

5. The plurality of sensors as claimed in claim 1, wherein, the plurality of sensor comprises sensors of a wearable device that can be configured to provide behavioral or health data to the microcontroller.

6. The sound unit as claimed in claim 1, wherein, the sound unit generates loud sound in case threat is not neutralized within a specific time.

7. The human irritant chemical as claimed in claim 1, wherein, the human irritant chemical comprises a fluorescent dye configured to mark the attacker for easy identification.

8. A method to prevent, monitor and alert crime, wherein the method to prevent, monitor or alert crime is characterized by steps of:
configuring a personal protection device, wherein the personal protection device comprises steps of:
configuring a refillable ampule unit with a button so as to carry a human irritant chemical and spray the human irritant chemical on an attacker with a push of the push button;
configuring a plurality of sensors so as to detect behavioral changes, movement rate, distance of the attacker and geo location of the personal device to calculate required flow rate of spray of the human irritant chemical;
configuring an audio-visual capturing module so as to capture images, audios and videos;
configuring a storage device so as to store output of the audio-visual capturing module;
configuring a sound unit so as to generate loud sound;
configuring a microcontroller so as to
regulating flow of spray of the human irritant chemical at the rate calculated by the plurality of sensors;
sending files stored in the storage device along with the geo-location of the personal protection device to central serval via a communication channel in real-time; and
generating sound through the sound unit;
setting a central server, wherein setting of the central server comprises steps of:
configuring a machine learning unit so as to:
verifying validity of crime;
categorizing type of crime;
tagging the crime with geo location;
attaching files received from the storage device to the tagged crime;
configuring an artificial intelligence unit so as to:
identifying intensity of crime by evaluating category, attached files and output of the plurality of sensors;
identifying if anyone else is at the geo location;
provide a safest route for a user based on time and presence of security group; and
sending and receiving information to and from communication channel; and
configuring a communication unit so as to:
informing security group and emergency contacts about the crime, image of criminal, geo location and time; and
identifying presence of anyone at the geo location and notify about the crime;
receiving request to identify safest route by the user;
sending the request to the artificial intelligence unit to provide safest route based on time, location, crime, presence of security group;
receiving the safest route from the artificial intelligence unit; and
providing the safest route to the user.

9. The personal protection device as claimed in claim 1, wherein, the personal protection device comprises steps of configuring a power source so as to provide power to the plurality of sensors, the audio-visual capturing device, the storage device, the sound unit and the microcontroller.

10. The personal protection device as claimed in claim 1, wherein, the personal protection device comprises step of configuring a chain with a sensor to carry the personal protection device so as to notify microcontroller in case of any damage in the chain and to deactivate spray.

11. The crime prevention, monitoring and alerting device as claimed in claim 1, wherein, the crime prevention, monitoring and alerting device can be configured through a mobile application.

12. The plurality of sensors as claimed in claim 1, wherein, the plurality of sensor comprises sensors of a wearable device that can be configured to provide behavioral or health data to the microcontroller.

13. The sound unit as claimed in claim 1, wherein, the sound unit generates loud sound in case threat is not neutralized within a specific time.

14. The human irritant chemical as claimed in claim 1, wherein, the human irritant chemical comprises a fluorescent dye configured to mark the attacker for easy identification.
